(19) United States
(12) Patent Application Publication
(10) Pub. No.: US 2017/0195988 A1
(43) Pub. Date: Jul. 6, 2017

(54) MULTI PROFILE COMMUNICATION DEVICE

(71) Applicant: Microsoft Technology Licensing, LLC, Redmond, WA (US)

(72) Inventors: Ashfaque Tumbi, Redmond, WA (US); Chan Chaiyochlarb, Redmond, WA (US); Susan Chory, Seattle, WA (US)

(73) Assignee: Microsoft Technology Licensing, LLC, Redmond, WA (US)

(21) Appl. No.: 14/989,425

(22) Filed: Jan. 6, 2016

(51) Int. Cl. H04W 68/02; H04M 1/725

(52) U.S. Cl. CPC H04W 68/02; H04M 1/72552; H04W 88/06

(57) ABSTRACT

A method for use in categorizing and processing in-bound communications on a client computing device is provided. The method may include selecting a mode from a plurality of modes, the selected mode being switchable with other modes of the plurality of modes based on one or more context parameters, determining a priority list for a plurality of contact types based on the selected mode, receiving a plurality of in-bound communications, determining a contact type of the plurality of contact types for each in-bound communication of the plurality of the in-bound communications based on contact data for each in-bound communication, and presenting a separate notification for each contact type based on the determined priority list, each notification including a summary of received in-bound communications for that contact type.

### BACKGROUND

Managing different aspects of a person's life, such as the balance between work and personal life, has become increasingly important to users. However, current smartphones do not effectively separate different types of communications, such as separating work related calls from personal calls, which can make managing a work-life balance difficult. Similarly, users may divide their attention between other areas, such as two businesses, two homes in different regions, etc. Consequently, many people pay for multiple phone lines, either by buying multiple phones or using a Dual SIM device, in order to separate business calls from personal calls by giving specific phone numbers to different sets of people, in order to separate one business's calls from another, or to have a first phone for a first region and a second phone for a second region, etc. However, having multiple phone lines inherently increases costs, as well as being more difficult to manage than a single phone line.

### SUMMARY

To address the issues discussed above, a method for use in categorizing and processing in-bound communications on a client computing device is provided. The method comprises selecting a mode from a plurality of modes, the selected mode being switchable with other modes of the plurality of modes based on one or more context parameters, determining a priority list for a plurality of contact types based on the selected mode, receiving a plurality of in-bound communications, determining a contact type of the plurality of contact types for each in-bound communication of the plurality of the in-bound communications based on contact data for each in-bound communication, and presenting a separate notification for each contact type based on the determined priority list, each notification including a summary of received in-bound communications for that contact type.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example computing system for a multi profile communication device according to an embodiment of the present description.

FIG. 2 shows an example method for multi-profile communication using the computing system of FIG. 1.

FIG. 3 continues the example method of FIG. 2.

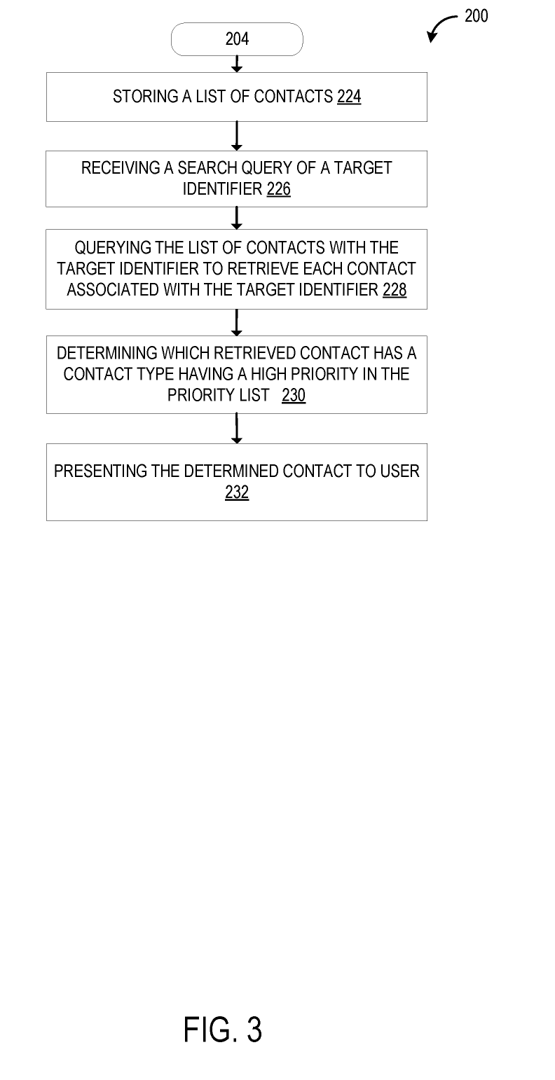

FIG. 4 shows an example graphical user interface of the computing system of FIG. 1.

FIG. 5 shows another example graphical user interface of the computing system of FIG. 1.

FIG. 6 shows another example graphical user interface of the computing system of FIG. 1.

FIG. 7 shows an example computing system according to an embodiment of the present description.

### DETAILED DESCRIPTION

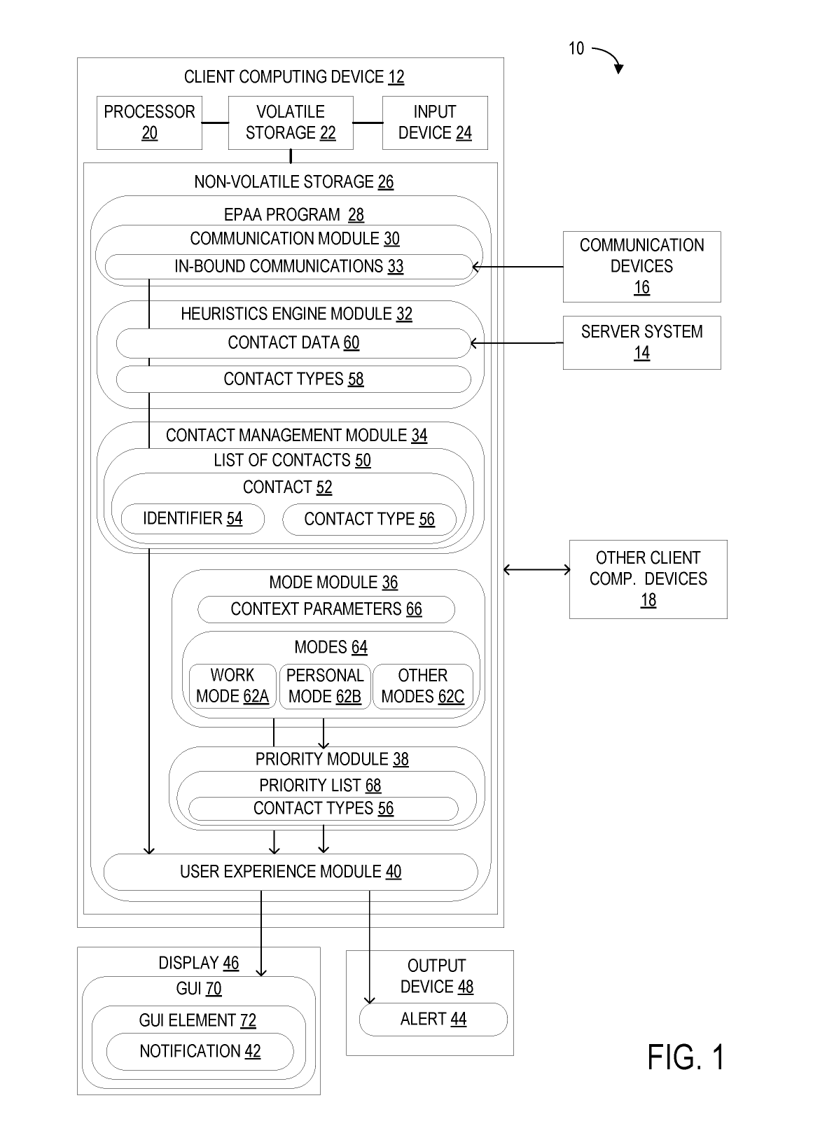

FIG. 1 illustrates a computing system 10 according to one embodiment of the present disclosure. As shown, the computing system 10 includes a client computing device 12, which, for example, may take the form of a smart phone, a tablet computing device, a desktop computing device, a wrist mounted device, etc., configured to communicate via a communication network with a server system 14 and communication devices 16, which may include smart phones, tablet computing devices, laptops, desktop computers, etc. The communication network includes wide area networks, Bluetooth, cellular IP networks, wireless local area networks, etc. Computing system 10 may also include other client computing devices 18 configured to communicate with client computing device 12. The other client computing devices 18 may include wearable computing devices, which may take the form of a wrist mounted device or head mounted device, or personal computers, which may take the form of a laptop or desktop computer. Herein, where functions of the client computing device 12 are described, it will be appreciated that any of the other client computing devices 18 may function in the same manner, unless the specific form factor of the device is mentioned explicitly.

Client computing device 12 includes a processor 20, a volatile storage 22, an input device 24, and a non-volatile storage 26. The input device 24 may take the form of a keyboard, a mouse, a touch sensor, a microphone, etc. The non-volatile storage 26 includes instructions for an electronic personal assistant application program 28 executed by a processor 20 of the client computing device 12. It will be appreciated that other instances of the electronic personal assistant application program 28 may be executed on the other client computing devices 18 in addition to or in collaboration with the electronic personal assistant application program 28 executed on the client device 12. In one embodiment, the electronic personal assistant application program 28 may be executed by networked computing devices, including the client computing device 12 and server system 14, in a cloud computing configuration.

As illustrated in FIG. 1, the electronic personal assistant application program 28 executed on the client computing device 12 includes a communication module 30, a heuristics engine module 32, a contact management module 34, a mode module 36, a priority module 38, and a user experience module 40. The electronic personal assistant application program 28 is configured to process in-bound communications received from communication devices 16, and present a notification 42 and an alert 44 of the received in-bound communications. In one embodiment, the notification 42 is presented via a display 46, which may take the form of a smartphone display, a desktop computer monitor, a wearable computing device display, etc. The alert 44, which may be a user perceptible alert such as a ringtone, a vibration, etc., or another type of alert such as a visual alert, is presented via an output device 48, which may be a speaker, a vibration motor, etc. It will be appreciated that the alert 44 may be presented via the display 46 when the alert 44 takes the form of a visual alert.

The electronic personal assistant program 28 is configured to customize the notifications 42 and alert 44 for in-bound communications based on user data. Subject to authorization by a user, the electronic personal assistant application program is configured to passively monitor various user data, such as location data, contacts, social network data, calendar data, in-bound and out-bound communication data, 3^{rd} party platform data network data, email data, etc. In one specific example, the electronic personal assistant application program 28 is configured to determine whether an in-bound communication is from a work-related contact or a personal contact, and whether the user is at work or at home based on the various user data, and customize the notifications 42 and the alert 44 accordingly. For example, the user of the client computing device 12 may configured settings to not be bothered by work related calls when at home. Accordingly, the electronic personal assistant application program 28 may be configured to suppress the alert 44, if the in-bound communication is from a work-related contact and the user of the client computing device 12 is at home.

Specific examples of these various types of user data will now be described. Location data may include for example, GPS coordinate data (latitude and longitude) obtained by a GPS receiver implemented on any client computing device, an identifier such as an IP address and/or Wi-Fi access point identifier that can be resolved to a generalized geographic location, a user check-in at a location via a social network program, etc. The contacts include names and contact information for individuals or organizations saved in a user contact database on client computing device 12, or retrieved from an external site, such as a social network website, or retrieved from an email service. The social network data may include a user's friends list, a list of social network entities “liked” by the user, check-ins made by the user at locations via a social network program, etc. The in-bound and out-bound communication data may be used to determine a calling pattern of the user, such as when the user takes calls or blocks calls from specific users. It will be appreciated that these specific examples are merely illustrative and that other types of user data specifically not discussed above may also be monitored.

As illustrated in FIG. 1, the electronic personal assistant application program 28 includes a communication module 30 configured to receive a plurality of in-bound communications 33, received from the communication devices 16 operated by other users, such as smart phones, tablet computing devices, laptops, desktop computers, etc. The in-bound communications 33 may take the form of a telecommunication, a Voice over IP (VoIP) call, a video call, a text for a short text message service (SMS), an email, etc. After receiving an in-bound communication, the electronic personal assistant application program 28 determines whether the in-bound communication is associated with a contact in a list of contacts 50 stored in the contact management module 34.

The contact management module 34 of the electronic assistant application program 28 is configured to store a list of contacts 50, each contact 52 associated with an identifier 54 and a contact type 56 of a plurality of contact types 58. The identifier may include both a name of the contact and one or more communication addresses. In one specific example, the name of the contact may be “Susan”, and the communication address may be a telephone number. However, the one or more communication addresses may take other forms, such as a VoIP address, an application specific user identification, etc. In one embodiment, the plurality of contact types 58 includes a work contact type and a personal contact type. However, the plurality of contact types 58 may also include other contact types, such as a family contact type, an unknown contact type, an acquaintance contact type, or virtually any other suitable contact type.

The list of contacts 50 stored in the contact management module 34 may be generated through several methods. For example, contacts from a social media account of the user of the client computing device 12 may be imported and stored in the contact management module 34. It should be appreciated that contacts may be imported from other sources, such as contacts associated with the user's email account, contacts associated with a VoIP platform account of the user, contacts stored in the other client computing devices 18 of the user, etc. The contacts 52 may also be manually added to the list of contacts 50 by the user of the client computing device 12. For example, the user may manually enter a contact including an identifier 54 with a name and communication address. If an in-bound communication is not associated with a contact 52 in the list of contacts 50, the electronic personal assistant program 28 may be configured to generate a new contact for that in-bound communication, and prompt the user of the client computing device 12 to enter a name for the contact.

In one embodiment, the contact type 56 for each contact 52 may be determined by prompting the user of the client computing device 12 to select a contact type of the plurality of contact type 58 or enter a new contact type. In another embodiment, the heuristics engine module 32 is configured to determine a contact type 56 of the plurality of contact types 58 for each in-bound communication of the plurality of the in-bound communications 33 based on contact data 60 for each in-bound communication. For example, contact data 60 may indicate that the in-bound communication is associated with a contact 52 stored in the list of contacts 50 that was imported from contacts associated with the user's work email account. Thus, the heuristics engine module 32 determines that the contact 52 for the in-bound communication has a work contact type, and may be further configured to prompt the user to confirm the determined contact type. It will be appreciated that the heuristics engine module 32 may determine the contact type 56 for each contact 52 either at the time that the contact 52 was generated, or at the time that the in-bound communication is received.

The contact data 60 may include the passively monitored various user data discussed above as well as other types of contact data 60 including a telecommunication number, geographic data, calling patterns, social media data, and email data. Specific examples of the contact data 60 will now be described. As discussed above, the contact data 60 may include a source of the contact. Contacts imported from a personal social media service such as FACEBOOK or the user's personal email accounts such as HOTMAIL may indicate that the contact has a personal relationship with the user. Contacts imported from a business orientated social media service such as LINKED-IN or the user's work email accounts such as EXCHANGE may indicate that the contact has a business orientated relationship with the user. The contact data 60 may also include calling patterns between the user and the contacts 52. For example, if the user's in-bound and out-bound calls with a contact generally occur from 9 A.M. to 5 P.M., Monday-Friday, then such a calling pattern may indicate that the contact has a business orientated relationship with the user. On the other hand, if the user's in-bound and out-bound calls with a contact typically fall on after-work hours or the weekends, then such a calling pattern may indicate that the contact has a personal relationship with the user. Calling pattern contact data may also include patterns for when the user answers or ignores in-bound communications from a contact. For example, if the user typically answers a contact during business hours and ignores that contact during non-business hours, such a calling pattern may indicate that the contact has a business orientated relationship with the user.

The contact data 60 may also include area codes or geolocations of the contacts. For example, if a particular contact has already been determined to be a work related contact, then other contacts having a similar geolocation as that contact may also be determined to have a business orientated relationship with the user. The contact data 60 may also include third party information received by the heuristics engine module 32 from third party sources of server system 14. For example, the contact data 60 may include data received from a business telephone directory or personal telephone directory at a third party server, which may include additional information associated with a particular contact. Specifically, the contact data 60 received from the business telephone directory or personal directory at the third party server may indicate whether the communication address of a contact has a known association with a particular business or a private individual. A known associated with a business may indicate that the contact has a business orientated relationship with the user. It will be appreciated that other third party services may be included in the server system 14 from which the client computing device 12 may receive contact data 60. Additionally, the server system 14 may include first party servers associated with the electronic personal assistant application program 28. For example, the first party servers may include contact data gathered from other communication devices 16 taking the form of another client computing device 12. It will be appreciated that these specific examples are merely illustrative and that other types of contact data 60 specifically not discussed above may also be utilized by heuristics engine module 32.

In some embodiments, portions or all of the heuristics engine module 32 is configured to be executed on a first party server of server system 14 associated with client computing device 12. For example, the heuristics engine module 32 may be execute via cloud computing that may include processor 20 on the client computing device 12 and processors of first party servers of server system 14. Additionally, the list of contacts, contact data, contact types, and the various user data may be transmitted to and stored in a user account on a first party server of server system 14 associated with client computing device 12.

As illustrated in FIG. 1, the electronic personal assistant application program 26 includes a mode module 36 configured to select a mode 62A/62B/62C from a plurality of modes 64, the selected mode being switchable with other modes of the plurality of modes 64 based on one or more context parameters 66. In one embodiment, the plurality of modes 64 includes a work mode 62A and a personal mode 62B. However, it will be appreciated that the plurality of modes 64 may include any number of other modes 62C. For example, the other modes 62C may include a quiet mode, a movie mode, an airplane mode, an entertainment mode, etc.

The mode module 36 is configured to select one of the modes of the plurality of modes 64 based on context parameters 66, which may include a geolocation of a user, a detected Wireless Local Area Network, a current date, and a current time of day. Specific examples of the context parameters 66 will now be described. The geolocation of the user, which may be passively monitored as the various user data may be used to determine a geolocation of the user's work and home. For example, the user's geolocation is typically at a particular location during business hours, the mode module 36 may determine that the location is the user's work, and may be configured to switch the mode of the plurality of modes 64 to the work mode 62A. On the other hand, if the user's geolocation is typically at a particular location during after-business hours or on weekends, then the mode module 36 may determine that the location is the user's home, and may be configured to switch the mode to the personal mode 62B. As another example, if the user's geolocation is rapidly changing, then the mode module 36 may determine that the user is currently flying on a plane, and may be configured to switch the mode to the airplane mode of the other modes 62C. Similarly, the detected Wireless Local Area Networks may be used to determine the user's current location in the same manner as with the user's geolocation. For example, if a particular set of Wireless Local Area Networks are typically detected by the client computing device 12 during business hours, then the mode module 36 may determine that the set of detected Wireless Local Area Networks indicate that the user is at work, and may be configured to switch the mode to the work mode 62A. Conversely, if a particular set of Wireless Local Area Networks are detected by the client computing device 12 during after-business hours or on weekends, then the mode module 36 may determine that the user is at home, and may be configured to switch the mode to the personal mode 62B.

In yet another example, if the mode module 36 may determine whether the user is at work or at home based on a current date and a current time of day. For example, if the current date is a weekday, and the current time is within normal business hours, the mode module 36 may determine that the user is at work and may be configured to switch the mode to the work mode 62A. On the other hand, if the current date is a weekend, or the current time of day is after-business hours, the mode module 36 may determine that the user is at home and may be configured to switch the mode to the personal mode 62B. It will be appreciated that certain users may not necessarily work during normal business hours, or may work on weekends. Thus, the mode module 36 may be configured to utilize multiple context parameters 66, and may be configured to learn behavior patterns of the user of the client computing device 12. For example, the mode module 36 may determine that the user typically takes calls from contacts having a work contact type only on the days Wednesday-Sunday, and typically ignore those work contacts on Monday and Tuesday. Thus, the mode module 36 may determine that the user works on Tuesday-Sunday, and may be configured to switch the mode to the work mode on Tuesday-Sunday. It will be appreciated that these specific examples are merely illustrative and that other types of context parameters 66 specifically not discussed above may also be utilized by mode module 36 to select a mode 62A/62B/62C of the plurality of modes 64.

The selected mode is sent to the priority module 38 and the user experience module 40, which are also updated each time the mode module 36 switches the selected mode to another mode of the plurality of modes 36. The priority module 38 is configured to determine a priority list 68 for a plurality of contact types 56 based on the selected mode. The priority list 68 may take the form of a list that ranks each contact type of the plurality of contact types 56 in order based on priority. Alternatively, the priority list 68 may take the form of a list that groups the plurality of contact types 56 into different groups having different priority levels. For example, an in-bound communication with a contact type having a high priority in the priority list 68 may have a prominent notification 42 as well as an alert 44, while an in-bound communication with a contact type having a low priority in the priority list 68 may have a less prominent notification 42 and no alert 44. In another embodiment, the priority list 68 may be a collection of settings generated for each contact type or mode. For example, the work mode 62A may include a setting that only in-bound communications 33 having a work contact type have a alert, and in-bound communications 33 having other contact types do not have an alert, so as to prevent the user from being interrupted by non-work related calls while at work. The collection of these settings, which may be altered by the user, may form the priority list 68. It will be appreciated that these specific examples are merely illustrative and that other types of priority lists 68 specifically not discussed above may also be utilized by priority module 38 to process in-bound communications 33 based on the selected mode 62A/62B/62C for the user.

Additionally, it will be appreciated that each mode of the plurality of modes 64 may have different priority lists 68 for the plurality of contact types 56. In one embodiment, if the selected mode is the work mode 62A, the determined priority list 68 includes the work contact type having a high priority and the personal contact type having a low priority. On the other hand, if the selected mode is the personal mode, the determined priority list includes the personal contact type having a high priority and the work contact type having a low priority. In a similar manner, each contact type of the plurality of contact types 58 may have a high priority or a low priority in the priority list 68 for the selected mode. It will be appreciated that the contact types are not limited to only a high priority or a low priority in the priority list 68, but may also have a medium priority, important priority, etc. Additionally, the priority level of some contact types of the plurality of contact types 58 may not necessarily change depending on the selected mode. For example, a family contact type may have a high priority in all priority lists 68 for the plurality of modes 64. Thus, it will be appreciated that the priority level of each contact type may change depending upon the selected mode.

As illustrated in FIG. 1, the in-bound communications 33, the contacts 52 associated with the in-bound communications, the selected mode, and the priority list 68 for the selected mode are sent to the user experience module 40. In one embodiment, the user experience module 40 is configured to present a separate notification 42 for each contact type 56 based on the determined priority list 68, each notification 42 including a summary of received in-bound communications 33 for that contact type 56. For example, the user experience module 40 may present a work notification which indicates to the user, a summary of each in-bound communication 33 associated with a contact 52 having the work contact type. In one specific example, each notification includes a number indicating the number of missed in-bound communications received for the contact type of that notification. Thus, a work notification may indicate the number of missed work related in-bound communications, a home notification may indicate the number of missed personal related in-bound communications, and so forth for each other contact type of the plurality of contact types 58.

Additionally, the notifications for each contact type 56 are presented based on the determined priority list. In one embodiment, the notification 42 for a contact type 56 having a high priority in the priority list 68 is presented more prominently than a contact type 56 having a low priority in the priority list 68. It will be appreciated that the notifications may be presented more prominently based on the type of notification. For example, the notification 42 may take the form of an audio output, and presenting the notification more prominently may include outputting the audio notification for a high priority contact type at a higher volume than the audio notification for a low priority contact type. For graphical notifications, the notification may be more prominently displayed by, for example, displaying the graphical notification in a larger size, more prominent position such as higher toward top of a vertically scrollable page, using an emphasized font, or in a highlighted color.

In one embodiment, the user experience module 40 is further configured to display a graphical user interface (GUI) 70 including a GUI element 72 for each contact type 58, wherein each notification 42 is presented via a GUI element 72 corresponding to the contact type 56 of that notification 42. In this embodiment, the GUI 70 may be displayed via the display 46. As discussed above, the client computing device 12 may include the display 46, which may take the form of a touchscreen, connected display, etc. Alternatively, the display 46 may be associated with the other client computing devices 18, such as a wrist mounted computing device that is communicatively connected to the client computing device 12 via Bluetooth. It will be appreciated that these specific examples are merely illustrative and that other types of displays 46 specifically not discussed above may also be utilized by the client computing device 12 to display the GUI 70.

Further in this embodiment, the user experience module 40 may be configured to organize the GUI 70 such that a GUI element 72 for a contact type 58 having a high priority is displayed higher in the GUI 70 than a GUI element 72 for a contact type 58 having a low priority. In one specific example of this embodiment, the GUI 70 includes a plurality of tile GUI elements, which are vertically scrollable from a top of page position to lower positions on the page via, for example, user swiping input on a touchscreen of the device. Each tile GUI element may represent a different application that may be executed by the client computing device 12. For example, the tile GUI elements may include a map application, a game application, etc. Accordingly, each contact type 58 may also have a corresponding tile GUI element in the GUI 70. The tile GUI element may present a notification for the corresponding contact type 58 including a summary of the received in-bound communications for that contact type 58, such as a number indicating the total number of missed calls for that contact type. By interacting with a particular tile GUI element, the user may be shown a detailed view of the in-bound communications received for that particular tile GUI element's associated contact type. For example, by interacting with a home tile GUI element, the user may view the received in-bound communications for personal contacts. On the other hand, by interacting with a work tile GUI element, the user may view the received in-bound communications for work contacts.

As discussed above, the user experience module 40 may be configured to organize the GUI 70 such that a GUI element 72 for a contact type 58 having a high priority is displayed higher in the GUI 70 than a GUI element 72 for a contact type 58 having a low priority. Thus, in the above example, the tile GUI element for a contact type having a high priority may be displayed at the top of GUI 70 where it is more easily and immediately noticeable by the user, and the tile GUI element for a contact type having a low priority may be displayed lower in the GUI 70 where it is less easily noticeable by the user. Additionally, it will be appreciated that the user experience module 40 may reorganize the GUI elements 72 when the mode is switched by the mode module 36 and the priority list 68 of contact types 56 has changed. For example, if the user is at work, and the current mode of the electronic assistant application program 28 is the work mode 62A, then the priority list 68 may include a work contact type having a high priority and a personal contact type having a low priority. Accordingly, the user experience module 40 may organize the GUI 70 such that the GUI element 72 for displaying a notification 42 for the work contact type is located at the top of the GUI 70, and the GUI element 72 for displaying a notification 42 for the personal contact type is located near the bottom of the GUI 70. Thus, while the user is at work, notifications associated with in-bound communications for work contact will be displayed at a more prominent and noticeable location for the user of the client computing device 12, and notifications associated with in-bound communications for personal contacts will be displayed at a less noticeable and less distracting location.

Next, when the user travels home, and the mode of the electronic personal assistant program 28 switches to the personal mode 62B, the priority list 68 for the contact types 56 may be inversed such that the work contact type has a low priority and the personal contact type has a high priority. Thus, the user experience module 40 may organize the GUI 70 such that the GUI element 72 for displaying a notification 42 for the personal contact type is located at the top of the GUI and the GUI element for displaying a notification 42 for the work contact type is located near the bottom of the GUI 70. It will be appreciated that these methods may be extended to embodiments that include additional priority levels in the priority list 68, additional modes, and additional contact types than those described above.

In one embodiment, the user experience module 40 also presents alerts to alert the user to an in-bound communication. In one example of this embodiment, in response to receiving the in-bound communication 33, if the determined contact type 58 of the in-bound communication 33 has a high priority in the priority list 68, the user experience module 40 is further configured to present an alert 44 of the in-bound communication 33, and if the determined contact type 56 of the in-bound communication 33 has a low priority in the priority list 68, the user experience module 40 is further configured prevent the alert 44 of the in-bound communication 33. In one specific example, if the electronic personal assistant application program 28 is in the work mode 62A, then in response to receiving an in-bound communication associated with a contact having the work contact type, the user experience module 40 may output a alert 44 via the output device 48, which may take the form of a user-perceptible ring-tone output via a speaker, a vibration output via a vibration motor, etc. It will be appreciated that the alert 44 may take other forms, and the specific form may be set by the user for each contact type 58 and mode 64. For example, the user may set that while in work mode 62A, work related in-bound communications have a ring-tone, and personal related in-bound communications have no user perceptible alert, or may have a less-user-perceptible alert such as a visual alert. The user may also set a different ring-tone for each contact type 58, or a different form of alert for each contact type to be output when a alert is allowed by the selected mode for that contact type.

Further in this embodiment, if the determined contact type 58 of the in-bound communication 33 has a low priority in the priority list 68, the user experience module 40 is further configured to determine whether the in-bound communication 33 is urgent, and if the in-bound communication 33 is urgent, allow the alert 44 of the in-bound communication 33. The user experience module 40 may determine that an in-bound communication 33 is urgent through several methods. For example, the user experience module 40 may include a breakthrough threshold, such that if the client computing device 12 receives a number of in-bound communications from a particular contact greater than the breakthrough threshold over a short period of time, then the user experience module 40 is configured to determine that the in-bound communication is urgent and break through the priority list 68 for the selected mode, including allowing a alert 44 for the in-bound communication. In another example, the user experience module 40 may determine that an in-bound communication 33 is urgent based on calling patterns determined by the heuristics engine module 32. For example, if a particular contact has a determined calling pattern of only calling on weekends, an in-bound communication from that contact that breaks the determined calling pattern, such as calling in the middle of the week, may be determined to be urgent. It will be appreciated that these specific examples are merely illustrative and that other methods specifically not discussed above may also be utilized by the user experience module 40 to determine whether an in-bound communication is urgent.

In one embodiment, the contact management module 34 is further configured to receive a search query of a target identifier from a user, query the list of contacts 50 with the target identifier to retrieve each contact 52 associated with the target identifier 54, determine which contact 52 among the retrieved contacts associated with the target identifier has a contact type 56 having a high priority in the priority list 68, and present the determined contact to the user. In one specific example of this embodiment, the user may enter a target identifier such as the name “Susan”. The contact management module 34 may then query the list of contact 50 with the identifier “Susan”, and retrieve each contact associated with the name “Susan”. Then, if the current mode is the personal mode 62B, then the contact management module 34 presents to the user, each contact associated with the name “Susan” and having a personal contact type which has a high priority. It will be appreciated that the contacts may be presented to the user dynamically as the user enters letters for the target identifier. Alternatively, the target identifier may be a telecommunication number, or an identifier for a VoIP platform contact, etc. Additionally, the retrieved contacts associated with the target identifier having a low priority in the priority list may also be presented less prominently to the user, such as at the bottom of a list of search results.

In some embodiments, the selected mode and priority list may be exposed to third party applications on the client computing device 12 or utilized by the electronic personal assistant application program 28 to organize first and third party applications on the client computing device 12. For example, when in the work mode 62A, the electronic personal assistant application program 28 may be configured to organize the GUI 70 such that GUI elements 72 associated with game applications are hidden from the user or displayed a locations towards the bottom of the GUI 70, and GUI elements 72 associated with work application are displayed more prominently for the user. In one embodiment, the GUI elements 72 associated with applications on the client computing device 12 may be organized in the GUI 70 according to a usage heuristic. For example, the heuristic engine module 32 may include a usage heuristic calculated for each application on the client computing device 12 for each mode of the plurality of modes 64. The user heuristic may be calculated based on the number of instances that the user opens a particular application while the client computing device 12 is in a particular mode, or based on the amount of time the user spends using each application while the client computing device 12 is in a particular mode. It will be appreciated that these specific examples are merely illustrative and that other methods specifically not discussed above may also be utilized by the heuristics engine module 32 to calculate a usage heuristic for each application on the client computing device 12. Thus, in one specific example of this embodiment, if the electronic personal assistant application program 28 is in the work mode 62A, then the user experience module 40 may organize the GUI 70 such that GUI elements 72 associated with applications having a high usage heuristic in the work mode 62A are displayed more prominently in the GUI 70 than GUI elements 72 associated with applications having a low usage heuristic in the work mode 62A. Next, when the electronic personal assistant application program 28 switches to the personal mode 62B, the user experience module 40 may reorganize the GUI 70 according to the usage heuristics of applications in the personal mode 62B. It will be appreciated that the usage heuristic is not limited to a high usage heuristic and a low usage heuristic, but may include a range of values. Thus, in some embodiments, the user experience module 40 may organize the GUI 70 such that the GUI elements 72 for applications are displayed in a descending fashion according to the usage heuristic calculated for each application, such that applications having a higher usage heuristic are displayed towards the top of the GUI 70 and application having a lower usage heuristic are displayed towards the bottom of the GUI 70.

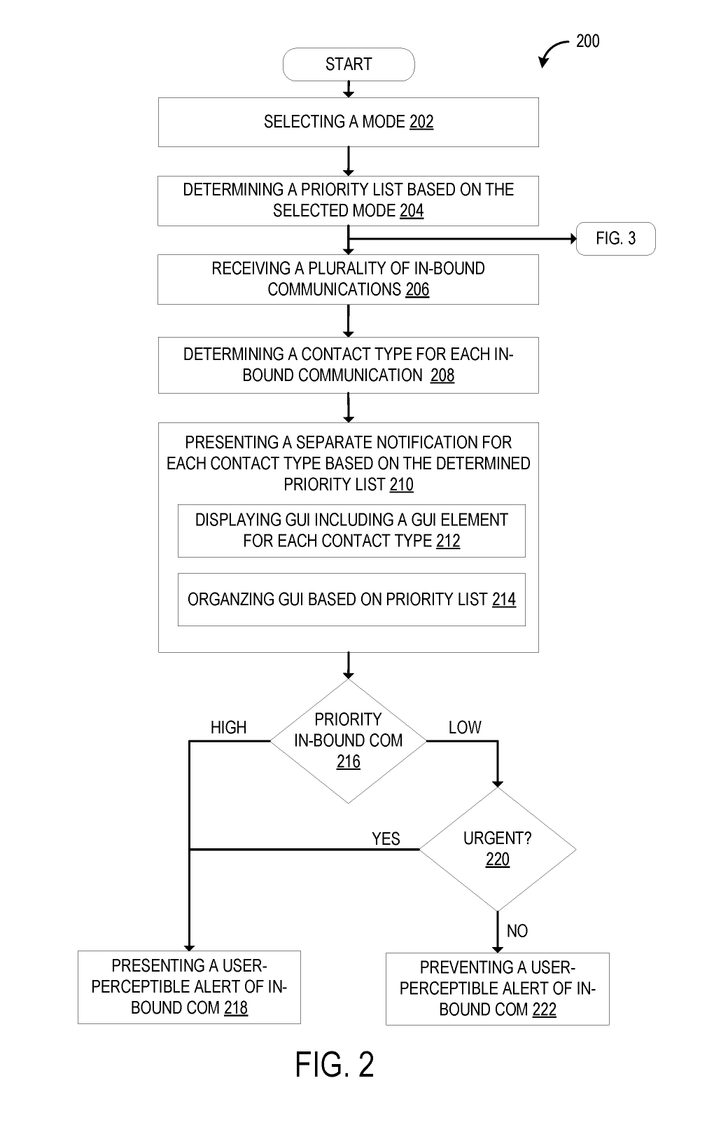

FIG. 2 shows an example method 200 according to an embodiment of the present description. At step 202, the method 200 may include selecting a mode from a plurality of modes, the selected mode being switchable with other modes of the plurality of modes based on one or more context parameters. In one embodiment, the plurality of modes includes a work mode and a personal mode. In another embodiment, the one or more context parameters are selected from the group consisting of: a geolocation of a user, a detected Wireless Local Area Network, a current date, and a current time of day.

Advancing from step 202 to step 204, the method 200 may include determining a priority list for a plurality of contact types based on the selected mode. In one embodiment, if the selected mode is the work mode, the determined priority list includes the work contact type having a high priority and the personal contact type having a low priority, and if the selected mode is the personal mode, the determined priority list includes the personal contact type having a high priority and the work contact type having a low priority.

Proceeding from step 204 to step 206, the method 200 may include receiving a plurality of in-bound communications. As discussed above, the plurality of in-bound communications may take the form of a telecommunication, a Voice over IP (VoIP) call, a video call, a text for a short text message service (SMS), an email, etc.

Advancing from step 206 to step 208, the method 200 may include determining a contact type of the plurality of contact types for each in-bound communication of the plurality of the in-bound communications based on contact data for each in-bound communication. In one embodiment, the plurality of contact types includes a work contact type and a personal contact type. In another embodiment, the contact data for the in-bound communication is selected from the group consisting of: a telecommunication number, geographic data, calling patterns, social media data, and email data.

Proceeding from step 208 to step 210, the method 200 may include presenting a separate notification for each contact type based on the determined priority list, each notification including a summary of received in-bound communications for that contact type. In one embodiment, the notification for a contact type having a high priority in the priority list is presented more prominently than a contact type having a low priority in the priority list.

Step 210 may further include sub-steps 212 and 214. Proceeding from step 210 to sub-step 212, the method 200 may include displaying a graphical user interface (GUI) including a GUI element for each contact type, wherein each notification is presented via a GUI element corresponding to the contact type of that notification. Advancing from sub-step 212 to sub-step 214, the method may include organizing the GUI such that a GUI element for a contact type having a high priority is displayed higher in the GUI than a GUI element for a contact type having a low priority.

Proceeding from step 210 to step 216, the method 200 may include, in response to receiving an in-bound communication, determining whether the determined contact type of the in-bound communication has a high priority or a low priority in the priority list. If the determined contact type of the in-bound communication has a high priority in the priority list, the method 200 advances from step 216 to step 218 and may include presenting a alert of the in-bound communication. On the other hand, if the determined contact type of the in-bound communication has a low priority in the priority list, the method 200 advances from step 216 to step 220 and may include determining whether the in-bound communication is urgent. If the in-bound communication is urgent, the method 200 proceeds from step 220 to step 218 and may include allowing the alert of the in-bound communication, and presenting the alert of the in-bound communication. If the determined contact type of the in-bound communication has a low priority in the priority list and the in-bound communication is not urgent, the method 200 advances from step 220 to step 222 and may include preventing the alert of the in-bound communication.

Turning back to step 204, the method 200 may optionally or additionally proceed to step 224 and may include storing a list of contacts, each contact associated with an identifier and a contact type of the plurality of contact types. Advancing from step 224 to step 226, the method 200 may include receiving a search query of a target identifier from a user. Proceeding from step 226 to step 228, the method 200 may include querying the list of contacts with the target identifier to retrieve each contact associated with the target identifier. Advancing from step 228 to step 230, the method 200 may include determining which contact among the retrieved contacts associated with the target identifier has a contact type having a high priority in the priority list. Proceeding from step 230 to step 232, the method 200 may include presenting the determined contact to the user.

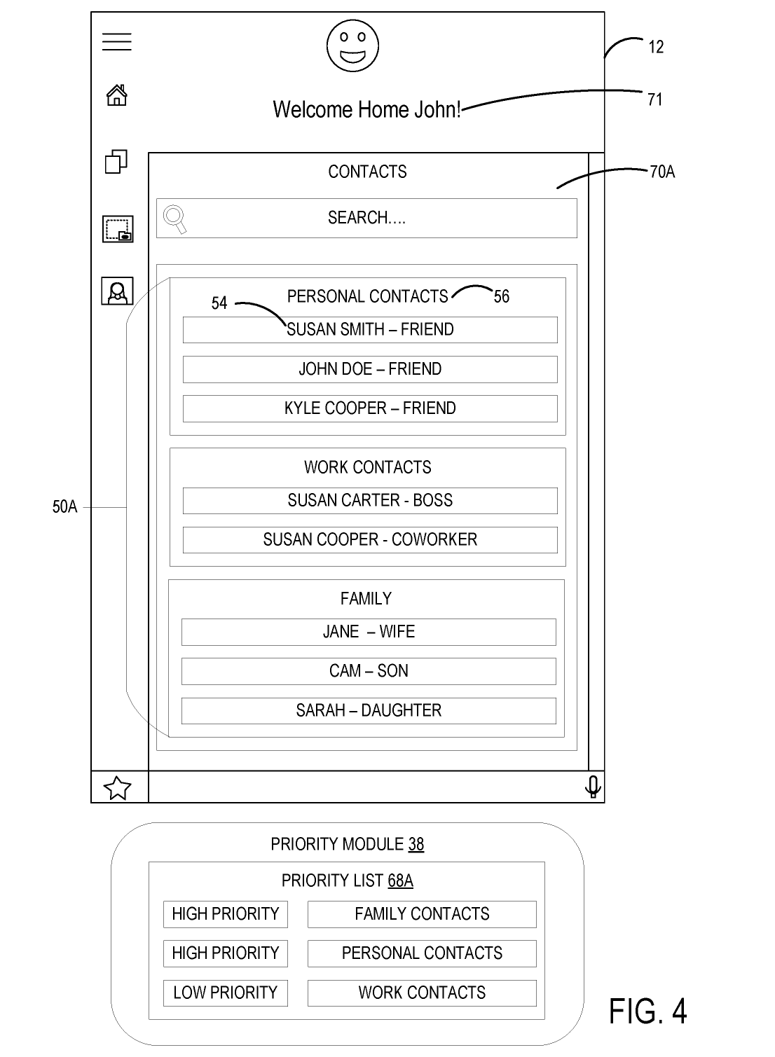

Now turning to FIG. 4, an example GUI displaying a user's list of contacts 50A is illustrated. In the illustrated example, the client computing device 12 is a smartphone configured to display a GUI 70A which includes a list of contacts 50A for the user. Each contact includes an identifier 54 and a contact type 56, which may be determined by the heuristics engine module 32 or entered by the user according to the methods discussed above. It should be appreciated that while only a name of the contact is shown in the illustrated example for the identifier 54, that the identifier also includes a communication address such as a telecommunication number. In this example, the plurality of contact types 58 includes three contact types, Personal Contacts, Work Contacts, and Family Contacts. However, as discussed above, the plurality of contact types 58 may include any number of contact types.

As illustrated, the GUI 70A includes a message 71 to the user indicating the current selected mode of the electronic personal assistant application program 28 is a personal mode 62B. In this example, the user has just arrived at a location that has been designated as home according to methods discussed above. Thus, the electronic personal assistant application program 28 switched modes to the current personal mode 62B. Next, the priority module 38 determined the priority list 68A which includes priority levels for the three contact types. In this example, the priority list only includes two priority levels, High and Low. However, it should be appreciated that the priority list may include any suitable number of priority levels. As the electronic personal assistant application program 28 is in the personal mode 62B, the Family Contact Type and Personal Contact Type both have a high priority in the priority list 68A, while the Work Contact Type has a low priority in the priority list 68A.

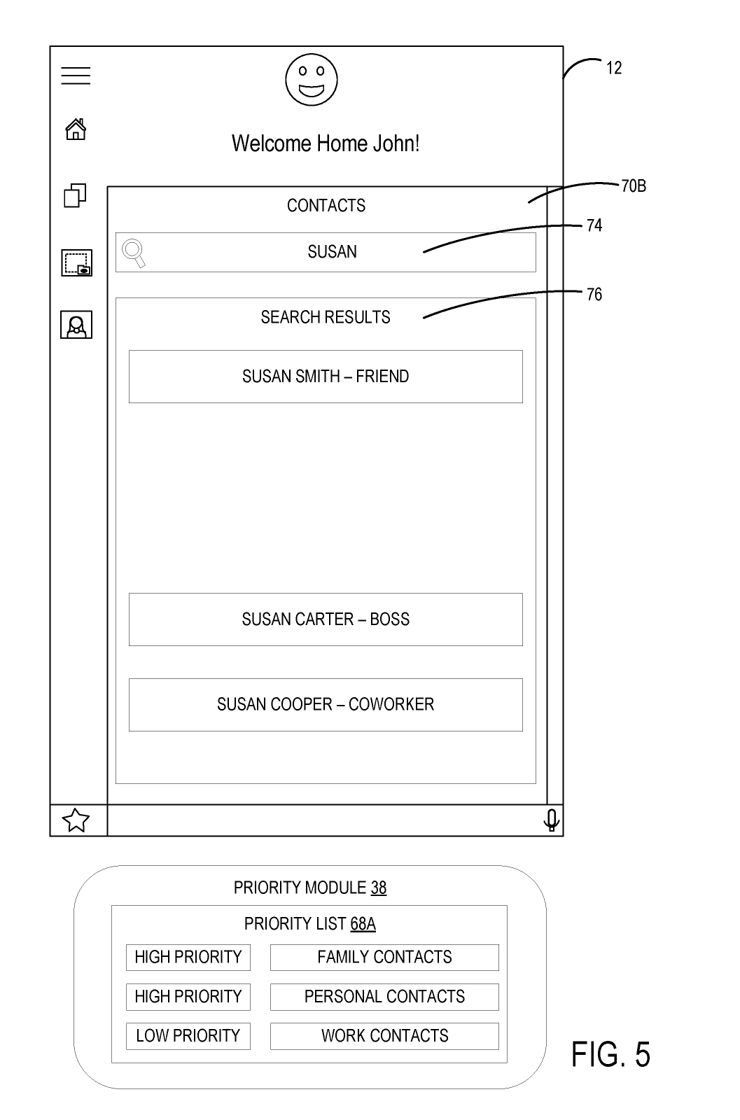

FIG. 5 illustrates an example search query 74 from the user of the client computing device 12. In this example, the contact management module 34 of the electronic personal assistant application program 28 includes the list of contacts 50A, the personal mode 62A, and the priority list 68A shown in FIG. 4. As illustrated, the user has entered a search query for the target identifier of “Susan”. The contact management module 34 is configured to query the list of contacts 50A with the target identifier of “Susan” to retrieve each contact associated with the target identifier. In the illustrated example, the list of contacts 50A includes three contacts associated with the target identifier “Susan”, including a first contact “Susan Smith”, a second contact “Susan Carter”, and a third contact “Susan Cooper”. Before presenting these retrieved contacts to the user in response to the search query 74, the electronic personal assistant application program 28 organizes the retrieved contacts based on the priority list in order to place the retrieved contact that the user is most likely searching for at the top of the search results 76. In this example, the first contact “Susan Smith” has a Personal Contact Type, whereas both the second and third contacts “Susan Carter” and “Susan Cooper” have a Work Contact Type. Thus, based on the priority list 68A, the contact management module 34 determines that the first contact “Susan Smith” is the contact among the retrieved contacts associated with the target identifier “Susan” that has a contact type having a high priority in the priority list 68A. Accordingly, the user experience module 40 displays the GUI 70B which includes the search results 76 with the first contact “Susan Smith” being presented at the top of the search results 76. In some embodiments, the user experience module 40 may present only the retrieved contacts having a contact type with a high priority in the priority list.

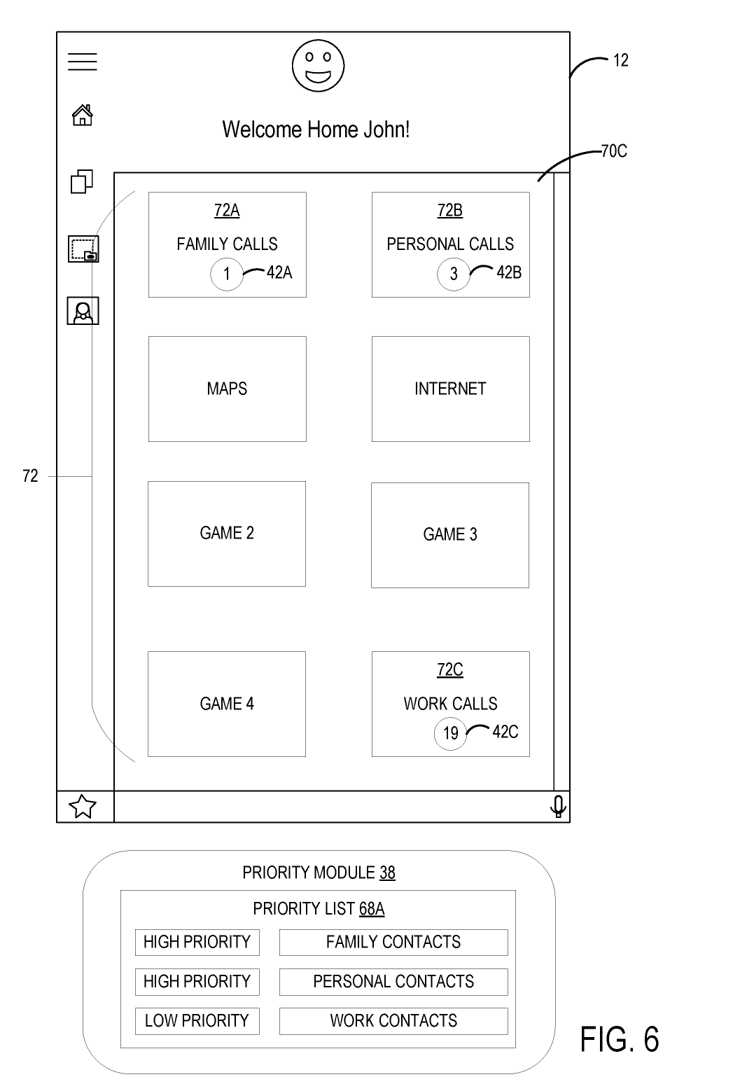

Now turning to FIG. 6, the client computing device 12 is configured to display a GUI 70C, which includes a plurality of GUI elements 72. The plurality of GUI elements 72 includes GUI elements for first party applications such as a map application and an internet application installed on the client computing device 12. As illustrated, because the electronic personal assistant application program 28 of the client computing device 12 is currently in the Personal Mode 62B, the plurality of GUI elements 72 may also include GUI elements for third party games. In some embodiments, when the electronic personal assistant application program 28 switches to a Work Mode 62A, the user experience module 40 may be configured to hide the GUI elements for third party games. It will be appreciated that the user experience module 40 may include settings to hide or reveal GUI elements for various applications based on the current mode of the electronic personal assistant application program 28 in a similar manner.

As illustrated, the GUI 70C includes a GUI element for each contact type, including a GUI element 72A for the Family Contact Type, 72B for the Personal Contact Type, and 72C for the Work Contact Type. Additionally, as the current mode of the electronic personal assistant application program 28 is the Personal Mode 62B, the user experience module 40 is configured to display the GUI elements for contact types having a high priority in the priority list 68A more prominently than GUI elements for contact types having a low priority in the priority list 68A. Thus, in the illustrated example, the GUI elements 72A and 72B for the Family Contact Type and the Personal Contact Type are organized to be at the top of the GUI 70C where they may be seen more easily by the user, while the GUI element 72C for the Work Contact Type is organized to be at the bottom of the GUI 70C.

Additionally, in the illustrated example, a separate notification for each contact type is included in the GUI elements. As shown, the GUI element 72A for the Family Contact Type includes a notification 42A which includes a summary of the in-bound calls having the Family Contact Type. In this example, the summary is the number of missed in-bound calls having that contact type. Thus, the notification 42A includes a “1”, indicating that the user has one missed call from a family member. Similarly, each separate notification for each contact type includes separate summaries for the in-bound communications for those contact types. As shown, the GUI element 72B includes notification 42B with a summary for the in-bound communications having a Personal Contact Type, and the GUI element 72C includes notification 42C with a summary for the in-bound communications having a Work Contact Type. It will be appreciated that the notifications and summaries for in-bound communications are not limited to numbers, by may include any suitable type of notification. For example, the notifications 42 may include information summarizing which specific contacts for each contact type from which the client computing device 12 received in-bound communications.

In some embodiments, the methods and processes described herein may be tied to a computing system of one or more computing devices. In particular, such methods and processes may be implemented as a computer-application program or service, an application-programming interface (API), a library, and/or other computer-program product.

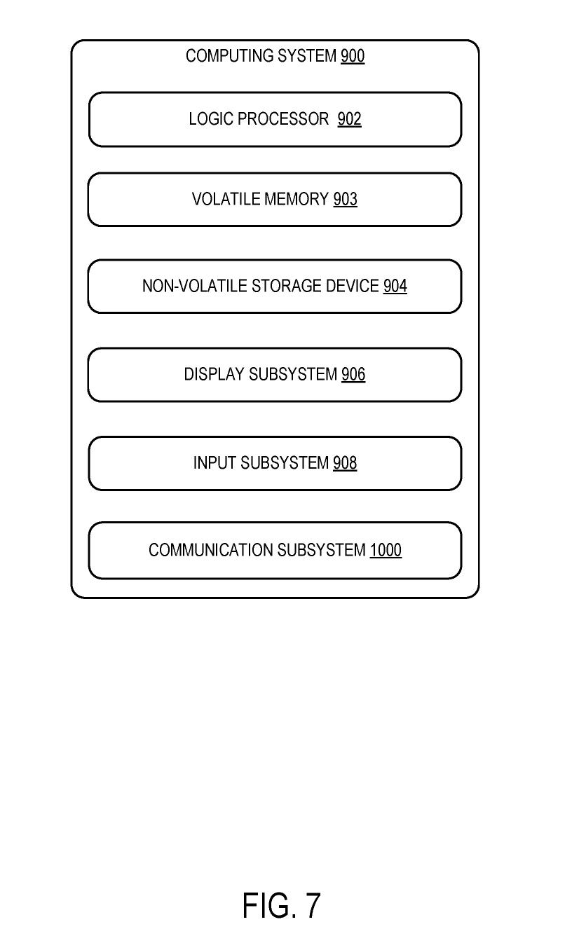

FIG. 7 schematically shows a non-limiting embodiment of a computing system 900 that can enact one or more of the methods and processes described above. Computing system 900 is shown in simplified form. Computing system 900 may embody one or more of the servers of server system 14 or client computing device 12 or other client computing devices 18 of FIG. 1. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 903, and a non-volatile storage device 904. Computing system 900 may optionally include a display subsystem 906, input subsystem 908, communication subsystem 1000, and/or other components not shown in FIG. 7.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 94 may be transformed—e.g., to hold different data.

Non-volatile storage device 904 may include physical devices that are removable and/or built-in. Non-volatile storage device 94 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

The following paragraphs provide additional support for the claims of the subject application. One aspect provides a method for use in categorizing and processing in-bound communications on a client computing device, the method comprising: selecting a mode from a plurality of modes, the selected mode being switchable with other modes of the plurality of modes based on one or more context parameters, determining a priority list for a plurality of contact types based on the selected mode, receiving a plurality of in-bound communications, determining a contact type of the plurality of contact types for each in-bound communication of the plurality of the in-bound communications based on contact data for each in-bound communication, and presenting a separate notification for each contact type based on the determined priority list, each notification including a summary of received in-bound communications for that contact type. In this aspect, the method may additionally or alternatively include, wherein the plurality of modes includes a work mode and a personal mode, and the plurality of contact types includes a work contact type and a personal contact type, wherein if the selected mode is the work mode, the determined priority list includes the work contact type having a high priority and the personal contact type having a low priority, and wherein if the selected mode is the personal mode, the determined priority list includes the personal contact type having a high priority and the work contact type having a low priority. In this aspect, the method may additionally or alternatively include, wherein the notification for a contact type having a high priority in the priority list is presented more prominently than a contact type having a low priority in the priority list. In this aspect, the method may additionally or alternatively include, displaying a graphical user interface (GUI) including a GUI element for each contact type, wherein each notification is presented via a GUI element corresponding to the contact type of that notification, and organizing the GUI such that a GUI element for a contact type having a high priority is displayed higher in the GUI than a GUI element for a contact type having a low priority. In this aspect, the method may additionally or alternatively include, in response to receiving the in-bound communication: if the determined contact type of the in-bound communication has a high priority in the priority list, presenting an alert of the in-bound communication, and if the determined contact type of the in-bound communication has a low priority in the priority list, preventing the alert of the in-bound communication. In this aspect, the method may additionally or alternatively include, wherein if the determined contact type of the in-bound communication has a low priority in the priority list, the method further comprises, determining whether the in-bound communication is urgent, and if the in-bound communication is urgent, allowing the alert of the in-bound communication. In this aspect, the method may additionally or alternatively includes, storing a list of contacts, each contact associated with an identifier and a contact type of the plurality of contact types, receiving a search query of a target identifier from a user, querying the list of contacts with the target identifier to retrieve each contact associated with the target identifier, determining which contact among the retrieved contacts associated with the target identifier has a contact type having a high priority in the priority list, and presenting the determined contact to the user. In this aspect, the method may additionally or alternatively include, wherein the one or more context parameters are selected from the group consisting of: a geolocation of a user, a detected Wireless Local Area Network, a current date, and a current time of day. In this aspect, the method may additionally or alternatively include, wherein the contact data for the in-bound communication is selected from the group consisting of: a telecommunication number, geographic data, calling patterns, social media data, and email data.

Another aspect provides a client computing device comprising: an electronic personal assistant application program executed by a processor of the client computing device, and including: a mode module configured to select a mode from a plurality of modes, the selected mode being switchable with other modes of the plurality of modes based on one or more context parameters, a priority module configured to determine a priority list for a plurality of contact types based on the selected mode, a communication module configured to receive a plurality of in-bound communications, a heuristics engine module configured to determine a contact type of the plurality of contact types for each in-bound communication of the plurality of the in-bound communications based on contact data for each in-bound communication, and a user experience module configured to present a separate notification for each contact type based on the determined priority list, each notification including a summary of received in-bound communications for that contact type. In this aspect, the client computing device may additionally or alternatively include, wherein the plurality of modes includes a work mode and a personal mode, and the plurality of contact types includes a work contact type and a personal contact type, wherein if the selected mode is the work mode, the determined priority list includes the work contact type having a high priority and the personal contact type having a low priority, and wherein if the selected mode is the personal mode, the determined priority list includes the personal contact type having a high priority and the work contact type having a low priority. In this aspect, the client computing device may additionally or alternatively include, wherein the notification for a contact type having a high priority in the priority list is presented more prominently than a contact type having a low priority in the priority list. In this aspect, the client computing device may additionally or alternatively include, the user experience module further configured to: display a graphical user interface (GUI) including a GUI element for each contact type, wherein each notification is presented via a GUI element corresponding to the contact type of that notification, and organize the GUI such that a GUI element for a contact type having a high priority is displayed higher in the GUI than a GUI element for a contact type having a low priority. In this aspect, the client computing device may additionally or alternatively include, in response to receiving the in-bound communication: if the determined contact type of the in-bound communication has a high priority in the priority list, the user experience module is further configured to present an alert of the in-bound communication, and if the determined contact type of the in-bound communication has a low priority in the priority list, the user experience module is further configured prevent the alert of the in-bound communication. In this aspect, the client computing device may additionally or alternatively include, wherein if the determined contact type of the in-bound communication has a low priority in the priority list, the user experience module is further configured to: determine whether the in-bound communication is urgent, and if the in-bound communication is urgent, allow the alert of the in-bound communication. In this aspect, the client computing device may additionally or alternatively include, the electronic personal assistant program further including a contact management module configured to: store a list of contacts, each contact associated with an identifier and a contact type of the plurality of contact types, receive a search query of a target identifier from a user, query the list of contacts with the target identifier to retrieve each contact associated with the target identifier, determine which contact among the retrieved contacts associated with the target identifier has a contact type having a high priority in the priority list, and present the determined contact to the user. In this aspect, the client computing device may additionally or alternatively include, wherein the one or more context parameters are selected from the group consisting of: a geolocation of a user, a detected Wireless Local Area Network, a current date, and a current time of day. In this aspect, the client computing device may additionally or alternatively include, wherein the contact data for the in-bound communication is selected from the group consisting of: a telecommunication number, geographic data, calling patterns, social media data, and email data.

Another aspect provides a client computing device comprising: a display, a processor configured to execute instructions stored on a non-volatile storage device, the instructions including: a mode module configured to select a mode from a plurality of modes, the selected mode being switchable with other modes of the plurality of modes based on one or more context parameters, the plurality of modes including a work mode and a personal mode, a communication module configured to receive a plurality of in-bound communications, a heuristics engine module configured to determine a contact type of the plurality of contact types for each in-bound communication of the plurality of the in-bound communications based on contact data for each in-bound communication, the plurality of contact types including a work contact type and a personal contact type, a priority module configured to determine a priority list for a plurality of contact types based on the selected mode, wherein if the selected mode is the work mode, the determined priority list includes the work contact type having a high priority and the personal contact type having a low priority, and wherein if the selected mode is the personal mode, the determined priority list includes the personal contact type having a high priority and the work contact type having a low priority, and a user experience module configured to: display a graphical user interface (GUI) on the display, the GUI including a GUI element for each contact type, present a separate notification for each contact type via the GUI element for each contact type, and organize the GUI such that a GUI element for a contact type having a high priority is displayed higher in the GUI than a GUI element for a contact type having a low priority. In this aspect, the client computing device may additionally or alternatively include, wherein the one or more context parameters are selected from the group consisting of: a geolocation of a user, a detected Wireless Local Area Network, a current date, and a current time of day, and wherein the contact data for the in-bound communication is selected from the group consisting of: a telecommunication number, geographic data, calling patterns, social media data, and email data.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for use in categorizing and processing in-bound communications on a client computing device, the method comprising:
selecting a mode from a plurality of modes, the selected mode being switchable with other modes of the plurality of modes based on one or more context parameters;
determining a priority list for a plurality of contact types based on the selected mode;
receiving a plurality of in-bound communications;
determining a contact type of the plurality of contact types for each in-bound communication of the plurality of the in-bound communications based on contact data for each in-bound communication; and
presenting a separate notification for each contact type based on the determined priority list, each notification including a summary of received in-bound communications for that contact type.

2. The method of claim 1, wherein the plurality of modes includes a work mode and a personal mode, and the plurality of contact types includes a work contact type and a personal contact type;
wherein if the selected mode is the work mode, the determined priority list includes the work contact type having a high priority and the personal contact type having a low priority; and
wherein if the selected mode is the personal mode, the determined priority list includes the personal contact type having a high priority and the work contact type having a low priority.

3. The method of claim 2, wherein the notification for a contact type having a high priority in the priority list is presented more prominently than a contact type having a low priority in the priority list.

4. The method of claim 3, further comprising:
displaying a graphical user interface (GUI) including a GUI element for each contact type, wherein each notification is presented via a GUI element corresponding to the contact type of that notification; and
organizing the GUI such that a GUI element for a contact type having a high priority is displayed higher in the GUI than a GUI element for a contact type having a low priority.

5. The method of claim 2, further comprising:
in response to receiving the in-bound communication:
if the determined contact type of the in-bound communication has a high priority in the priority list, presenting an alert of the in-bound communication; and
if the determined contact type of the in-bound communication has a low priority in the priority list, preventing the alert of the in-bound communication.

6. The method of claim 5, wherein if the determined contact type of the in-bound communication has a low priority in the priority list, the method further comprises,
determining whether the in-bound communication is urgent; and
if the in-bound communication is urgent, allowing the alert of the in-bound communication.

7. The method of claim 2, further comprising:
storing a list of contacts, each contact associated with an identifier and a contact type of the plurality of contact types;
receiving a search query of a target identifier from a user;
querying the list of contacts with the target identifier to retrieve each contact associated with the target identifier;
determining which contact among the retrieved contacts associated with the target identifier has a contact type having a high priority in the priority list; and
presenting the determined contact to the user.

8. The method of claim 1, wherein the one or more context parameters are selected from the group consisting of: a geolocation of a user, a detected Wireless Local Area Network, a current date, and a current time of day.

9. The method of claim 1, wherein the contact data for the in-bound communication is selected from the group consisting of: a telecommunication number, geographic data, calling patterns, social media data, and email data.

10. A client computing device comprising:
an electronic personal assistant application program executed by a processor of the client computing device, and including:
a mode module configured to select a mode from a plurality of modes, the selected mode being switchable with other modes of the plurality of modes based on one or more context parameters;
a priority module configured to determine a priority list for a plurality of contact types based on the selected mode;
a communication module configured to receive a plurality of in-bound communications;
a heuristics engine module configured to determine a contact type of the plurality of contact types for each in-bound communication of the plurality of the in-bound communications based on contact data for each in-bound communication; and
a user experience module configured to present a separate notification for each contact type based on the determined priority list, each notification including a summary of received in-bound communications for that contact type.

11. The client computing device of claim 10, wherein the plurality of modes includes a work mode and a personal mode, and the plurality of contact types includes a work contact type and a personal contact type;
wherein if the selected mode is the work mode, the determined priority list includes the work contact type having a high priority and the personal contact type having a low priority; and
wherein if the selected mode is the personal mode, the determined priority list includes the personal contact type having a high priority and the work contact type having a low priority.

12. The client computing device of claim 11, wherein the notification for a contact type having a high priority in the priority list is presented more prominently than a contact type having a low priority in the priority list.

13. The client computing device of claim 12, the user experience module further configured to:
display a graphical user interface (GUI) including a GUI element for each contact type, wherein each notification is presented via a GUI element corresponding to the contact type of that notification; and
organize the GUI such that a GUI element for a contact type having a high priority is displayed higher in the GUI than a GUI element for a contact type having a low priority.

14. The client computing device of claim 11, further comprising:
in response to receiving the in-bound communication:
if the determined contact type of the in-bound communication has a high priority in the priority list, the user experience module is further configured to present an alert of the in-bound communication; and
if the determined contact type of the in-bound communication has a low priority in the priority list, the user experience module is further configured prevent the alert of the in-bound communication.

15. The client computing device of claim 14, wherein if the determined contact type of the in-bound communication has a low priority in the priority list, the user experience module is further configured to:
determine whether the in-bound communication is urgent; and
if the in-bound communication is urgent, allow the alert of the in-bound communication.

16. The client computing device of claim 11, the electronic personal assistant program further including a contact management module configured to:
store a list of contacts, each contact associated with an identifier and a contact type of the plurality of contact types;
receive a search query of a target identifier from a user;
query the list of contacts with the target identifier to retrieve each contact associated with the target identifier;
determine which contact among the retrieved contacts associated with the target identifier has a contact type having a high priority in the priority list; and
present the determined contact to the user.

17. The client computing device of claim 10, wherein the one or more context parameters are selected from the group consisting of: a geolocation of a user, a detected Wireless Local Area Network, a current date, and a current time of day.

18. The client computing device of claim 10, wherein the contact data for the in-bound communication is selected from the group consisting of: a telecommunication number, geographic data, calling patterns, social media data, and email data.

19. A client computing device comprising:
a display;
a processor configured to execute instructions stored on a non-volatile storage device, the instructions including:
a mode module configured to select a mode from a plurality of modes, the selected mode being switchable with other modes of the plurality of modes based on one or more context parameters, the plurality of modes including a work mode and a personal mode;
a communication module configured to receive a plurality of in-bound communications;
a heuristics engine module configured to determine a contact type of the plurality of contact types for each in-bound communication of the plurality of the in-bound communications based on contact data for each in-bound communication, the plurality of contact types including a work contact type and a personal contact type;
a priority module configured to determine a priority list for a plurality of contact types based on the selected mode, wherein if the selected mode is the work mode, the determined priority list includes the work contact type having a high priority and the personal contact type having a low priority, and wherein if the selected mode is the personal mode, the determined priority list includes the personal contact type having a high priority and the work contact type having a low priority; and
a user experience module configured to:
display a graphical user interface (GUI) on the display, the GUI including a GUI element for each contact type;
present a separate notification for each contact type via the GUI element for each contact type; and
organize the GUI such that a GUI element for a contact type having a high priority is displayed higher in the GUI than a GUI element for a contact type having a low priority.

20. The client computing device of claim 19, wherein the one or more context parameters are selected from the group consisting of: a geolocation of a user, a detected Wireless Local Area Network, a current date, and a current time of day; and
wherein the contact data for the in-bound communication is selected from the group consisting of: a telecommunication number, geographic data, calling patterns, social media data, and email data.
